(19) United States
(12) Patent Application Publication
(10) Pub. No.: US 2025/0368236 A1
(43) Pub. Date: Dec. 4, 2025

(54) METHOD OF MITIGATING PATH PLANNING FAILURE MODES IN ROUTE FOLLOWING APPLICATIONS

(71) Applicant: GM GLOBAL TECHNOLOGY OPERATIONS LLC, Detroit, MI (US)

(72) Inventors: Jeffrey S. Parks, Ann Arbor, MI (US); Paul A. Adam, Milford, MI (US); Tetyana V. Mamchuk, Walled Lake, MI (US); Christopher M. Churay, Farmington Hills, MI (US); Harsh K. Patel, Farmington Hills, MI (US)

(73) Assignee: GM GLOBAL TECHNOLOGY OPERATIONS LLC, Detroit, MI (US)

(21) Appl. No.: 18/731,798

(22) Filed: Jun. 3, 2024

(51) Int. Cl. B60W 60/00; B60W 50/14

(52) U.S. Cl. CPC B60W 60/0053; B60W 50/14; B60W 2552/20; B60W 2552/53; B60W 2554/802; B60W 2556/45

(57) ABSTRACT

A method of mitigating path planning failure modes, including distinguishing an added lane versus lane splits; determining road geometry features; determining a distance between the added lane and the lane split; and mitigating a path by one of: giving a driver control of a vehicle; and retaining control of the vehicle via an electronic driving system. The method may include that the road geometry features include curvature and a curvature derivative, and/or using a go or no go decision to determine whether the driver gets control or whether the vehicle retains control, and/or determining a distance from add point to split point is greater than a first distance. The method may include determining whether a lane width at split point is greater than a second distance, and/or generating takeover requests for timely ceding control, and/or rationalizing viability of a created trajectory.

### INTRODUCTION

The present disclosure relates to methods for mitigating path planning failure modes in route following applications. This is a comprehensive planning algorithm for following lane splits and lane adds in route following applications. Currently no technologies exist for mitigating path planning failure modes in route following application.

### SUMMARY

A method of mitigating path planning failure modes, including distinguishing an added lane versus lane splits; determining road geometry features; determining a distance between the added lane and the lane split; and mitigating a path by one of: giving a driver control of a vehicle; and retaining control of the vehicle via an electronic driving system.

The method may include that the road geometry features include curvature and a curvature derivative. The method may include using a go or no go decision to determine whether the driver gets control or whether the vehicle retains control. The method may include determining a distance from add point to split point is greater than a first distance.

The method may include determining whether a lane width at split point is greater than a second distance. The method may include generating takeover requests for timely ceding control. The method may include rationalizing a viability of a created trajectory.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a system for mitigating path planning failure modes in one or more routes.

FIG. 2A is a schematic flow chart diagram of a method, or methods, for mitigating path planning failure modes in one or more routes, in concert with FIG. 2B.

FIG. 2B is a schematic flow chart diagram of a method, or methods, for mitigating path planning failure modes in one or more routes, in concert with FIG. 2A.

FIG. 3 is a schematic flow chart diagram of a method, or methods, for mitigating path planning failure modes in one or more routes.

FIG. 4 is a schematic flow chart diagram of a method, or methods, for mitigating path planning failure modes in one or more routes.

### DETAILED DESCRIPTION

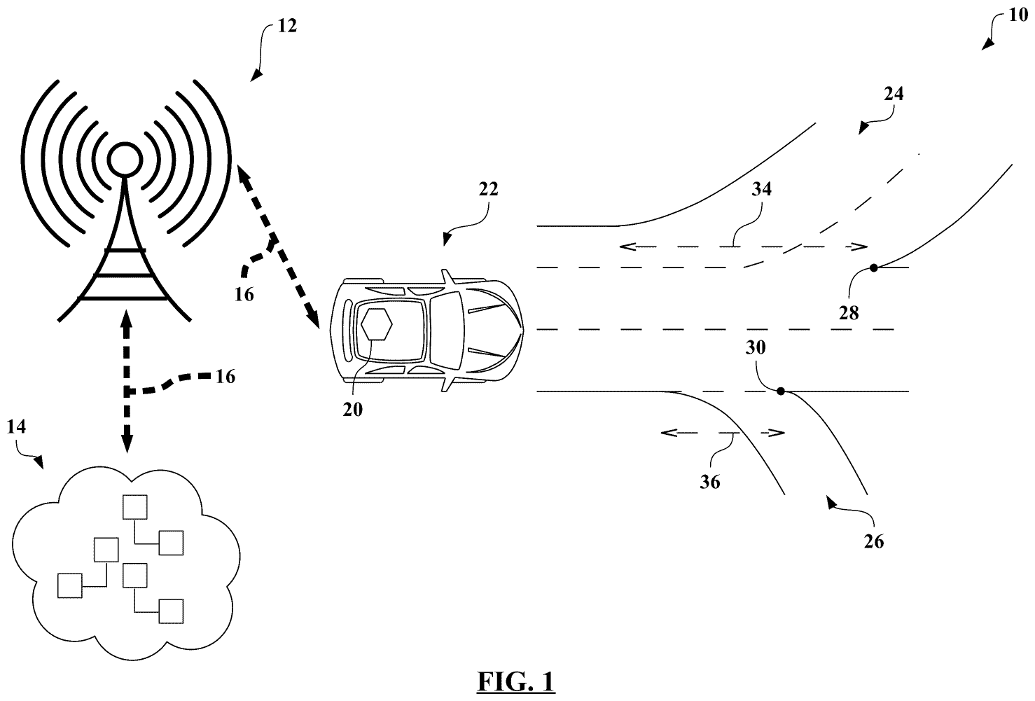

Referring to the drawings, like reference numbers refer to similar components, wherever possible. FIG. 1 schematically illustrates a connectivity network or connectivity system 10. The connectivity system 10 includes numerous components, only some of which are listed, and/or shown, herein.

A remote or cellular communications system, or cellular network 12, which may be representative of many types of communications protocols, including, without limitation: cellular, satellite, Wi-Fi, Bluetooth, ultra-wideband (UWB) or other communications recognizable to those having ordinary skill in the art. UWB is a radio-based communication technology for short-range use and fast and stable transmission of data.

A centralized location 14 is shown highly schematically, but may be representative of many different structures, clouds, servers, or elements, as will be recognized by skilled artisans. The centralized location 14 represents systems that communicate with some or all of the other systems and/or objects described herein. The centralized location 14 includes numerous controllers 20. Additionally, the centralized location 14 may be a back office (BO) of the manufacturer of the vehicles.

Several transfer protocols or transfers 16 are schematically illustrated. These transfers 16 may include, without limitation: cellular, Wi-Fi, wired networks, over-the-air (OTA), other transport protocols, including machine to machine (M2M), or other telematics equipment, or other systems recognizable by those having ordinary skill in the art. M2M systems use point-to-point communications between machines, sensors, and hardware over cellular, Wi-Fi, or wired networks.

The drawings and figures presented herein are diagrams, are not to scale, and are provided purely for descriptive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

The term vehicle is broadly applied to any moving platform. Vehicles into which the disclosure may be incorporated include, for example and without limitation: passenger or freight vehicles; autonomous driving vehicles; industrial, construction, and mining equipment; and various types of aircraft. Note that an electronic driving system is referenced herein. This may include numerous structures and sensors and may be referred to by numerous names, including, without limitation: self-driving, electronic driving systems, and/or autonomous driving mechanisms/systems.

All numerical values of parameters (e.g., of quantities or conditions) in this specification, including the appended claims, are to be understood as being modified in all instances by the term “about,” whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

A generalized control system, computing system, or controller 20 is operatively in communication with relevant components of all systems, and recognizable by those having ordinary skill in the art. The controller 20 includes, for example and without limitation, a non-generalized, electronic control device having a preprogrammed digital computer or processor, a memory, storage, or non-transitory computer-readable storage, upon which are recorded instructions, medium used to store data such as control logic, instructions, lookup tables, etc., and a plurality of input/output peripherals, ports, or communication protocols.

Furthermore, the controller 20 may include, or be in communication with, a plurality of sensors. Controller 20 is configured to execute or implement all control logic or instructions described herein and may be communicating with any sensors described herein or recognizable by skilled artisans. Any of the methods described herein may be executed by one or more controllers 20. Note that this algorithm is capable of running on, generally, less expensive controllers 20.

A vehicle 22 is shown in FIG. 1, but there may be other vehicles 22 that are not shown. Note that the vehicle 22 may not be to scale relative to the road features of FIG. 1. Additional elements in FIG. 1, include without limitation, an added lane 24 and a lane split 26—both of which are viewable in FIG. 1. The figure further includes a lane opening 28 and a split point 30. There also may be an added lane distance 34 and a lane split distance 36. Note that there may be additional lane splits 26. In general, the autonomous driving mechanisms/systems, or electronic driving systems, may be held within the one or more controllers 20, via the centralized location 14, or other mechanisms accessible via the cellular network 12, or others recognizable by those having ordinary skill in the art.

Note that the methods described herein may include curvature and a curvature derivative, as will be recognized by those having ordinary skill in the art. The following equations may be used to assist in the methods described herein.

$$F [ 0 ] = Path ID != Request Lane ID \qquad ( 1 )$$

$$F [ 1 ] = Path Relative Lane Relationship != Splitting Lane \qquad ( 2 )$$

$$F [ 2 ] = Path Offset ( 0 ) > {K}_{p a t {h}_{1}} \qquad ( 3 )$$

$$F [ 3 ] = Path {Offset}_{Splitting Lane} ( {K}_{d i s {t}_{1}} ) - Path {Offset}_{E g o L a n e} ( {K}_{d i s {t}_{1}} ) > {K}_{p a t {h}_{2}} \qquad ( 4 )$$

$$F [ 4 ] = {Width}_{SplittingLane} > {K}_{{W}_{1}} \qquad ( 5 )$$

$$F [ 5 ] = abs ( max ( {Curv}_{leftMarker} , Cur {v}_{r i g h t M a r k e r} ) ) > {K}_{C u r {v}_{1}} \qquad ( 6 )$$

$$F [ 6 ] = abs ( max ( \frac{d ( C u r {v}_{leftMarker} )}{d l} , \frac{d ( C u r {v}_{rightMarker} )}{d l} ) ) > {K}_{C u r {v}_{2}} \qquad ( 7 )$$

$$F [ 7 ] = ( d i s {t}_{f u l l W i d t h} - d i s {t}_{l a n e A d d} ) > {K}_{d i s {t}_{4}} \& \& ( d i s {t}_{f u l l W i d t h} - dis {t}_{l a n e A d d} ) < {K}_{d i s {t}_{2}} \qquad ( 8 )$$

$$F [ 8 ] = ( d i s {t}_{s p l i t} - d i s {t}_{f u l l W i d t h} ) > {K}_{d i s {t}_{3}} \qquad ( 9 )$$

$$F [ 9 ] = ( d i s {t}_{s p l i t} - d i s {t}_{l a n e A d d} ) > {K}_{d i s {t}_{4}} \qquad ( 10 )$$

$$F [ 10 ] = ( d i s {t}_{l a n e E n d} - d i s {t}_{f u l l W i d t h} ) > {K}_{d i s {t}_{5}} \qquad ( 11 )$$

$$F [ 11 ] , Block Lane Follow = \sum ( F ( n ) \& {K}_{mask} ) > 0 \qquad ( 12 )$$

In general, the route following lane add/split scenario adds a new layer of complexity to the lane centering application, and the margin for error is also lower as the shoulders are often narrower and concrete barriers may be present. First, controller 20 determines if the lane change required is the added lane 24 and/or the lane split 26. Generally, the lane split 26 can be followed directly, while the added lane 24 will be executed using a traditional automated lane change.

Second, controller 20 assesses the complexity of the upcoming route and generate heuristics based on known road geometry and features. Then, the controller 20 makes a “go” or “no go” decision. The no go decision will lead first to a message to driver of the vehicle 22 informing them that the vehicle 22 is unable to follow the route followed by a non-urgent escalation asking them the driver to take control. While this may be undesirable, it is far preferable to escalating mid-maneuver. Once the go decision is made, vehicle 22 continues driving until the start of the maneuver.

Then, in step 3, controller 20 executes the maneuver. While the maneuver is in process, the prognostics of the controller 20 continuously monitors the primary vs. escape trajectory. If the trajectory is invalid, controller 20 generates an urgent request for driver intervention, such that the driver of the vehicle 22 is notified to take over control. If the trajectory remains valid throughout the maneuver, the controller 20 finishes the maneuver and continues lane centering control along the driver's route.

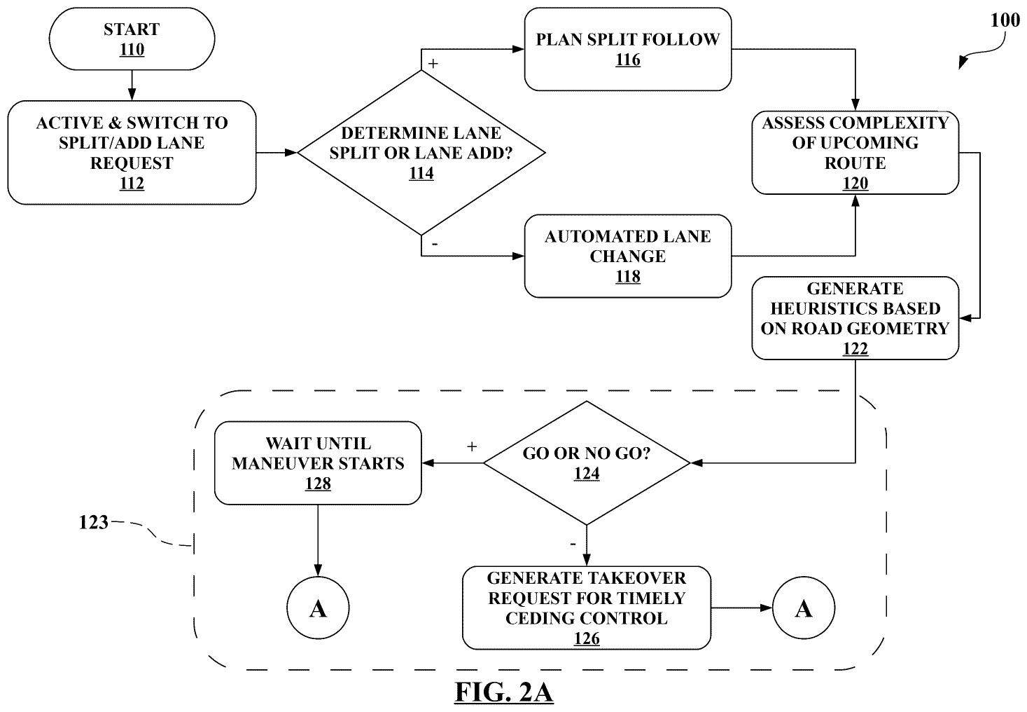

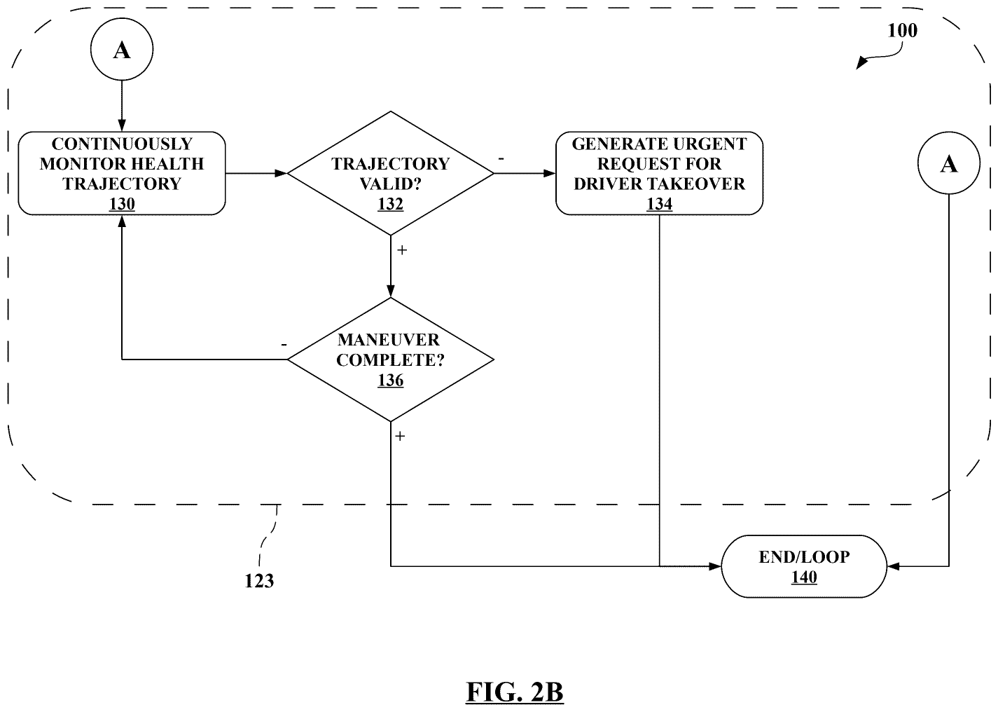

FIGS. 2A and 2B are a schematic flow chart diagram of a method 100, or methods, for mitigating path planning failure modes in route following application, note that method 100 may move back and forth between FIGS. 2A and 2B. Note that mitigating path planning failure modes will be recognized by those having ordinary skill in the art and may include numerous steps, which will be recognized by those having ordinary skill in the art. Mitigating path planning failure modes includes, without limitation, having the effect of making something less severe, such that the methods described herein limit many of the failure modes.

One or more of the methods described herein may be executed by controller 20, including the non-transitory computer-readable storage medium, or other structures or equipment recognizable to skilled artisans. All steps described herein may be optional, in addition to those explicitly stated as such, and all steps described may be reordered or removed. Any of the methods described herein may store the data in the centralized location 14 via the connectivity system 10.

Step 110: START. At step 110 the method 100 initializes or starts. Method 100 may begin operation when called upon by one or more controllers 20, may be constantly running, or may be looping iteratively.

Step 112: ACTIVE & SWITCH TO SPLIT/ADD LANE REQUEST. At step 112, method 100 realizes that there is the upcoming added lane 24 or the lane split 26 and activates the sensing system. This may include several steps that will be recognized by those having ordinary skill in the art.

Step 114: DETERMINE LANE SPLIT OR LANE ADD? At step 114, method 100 includes determining whether there is the added lane 24, lane adds, or the lane split 26. In this situation negative is the added lane 24 and positive is the lane split 26. This may include several steps that will be recognized by those having ordinary skill in the art. This includes distinguishing whether there is the added lane 24 or the lane split 26, and distinguishing the added lane 24 versus the lane split 26, as would be recognized by those having ordinary skill in the art.

Step 116: PLAN SPLIT FOLLOW. At step 116, the controller 20 plans to follow the lane split 26. The split follow maneuver entails directly following one or more lane markers on the desired side of the splitting lane. This may include several steps that will be recognized by those having ordinary skill in the art.

Step 118: AUTOMATED LANE CHANGE. At step 118, the controller 20 plans for the added lane 24. The automated lane change maneuver entails waiting until the newly added lane is at full width, activating a turn signal, creating a trajectory into the desired lane, and then executing that trajectory until the vehicle 22 is centered in the desired lane. This may include several steps that will be recognized by those having ordinary skill in the art.

Step 120: ASSESS COMPLEXITY OF UPCOMING ROUTE. At step 122, method 100 assesses the complexity of the upcoming route. This may include several steps that will be recognized by those having ordinary skill in the art. This may include, without limitation, distinguishing features of the road geometry.

Step 122: GENERATE HEURISTICS BASED ON ROAD GEOMETRY. At step 124, method 100 includes generating heuristics based on road geometry, which includes, without limitation, utilizing road geometry, traffic information and host vehicle dynamics, such that step 122 analyzes the road geometry. Note that, generally, everything in a dashed box 123 may be considered mid-maneuver or post-maneuver. Note that road geometry features will be recognizable to those having ordinary skill in the art and this may include, without limitation, determining road geometry features from the distinguished features of the road geometry.

Step 124: GO OR NO GO? At step 124, method 100 determines whether the vehicle 22 may keep on the previous trajectory or whether a driver of the vehicle 22 needs to take over control. This may include several steps that will be recognized by those having ordinary skill in the art. Note that the equations in paragraphs [0024]-[0035] may be used for this “go” or “no go” decision.

Step 126: GENERATE TAKEOVER REQUEST FOR TIMELY CEDING CONTROL. At step 126, if controller 20 determines that step 124 is negative, then the driver is informed in a timely manner such that they may take over to follow the vehicle 22 route. This may include several steps that will be recognized by those having ordinary skill in the art, including, without limitation, generating takeover requests for timely ceding control. Additionally, this may include sounding an alarm or alerting the driver of vehicle 22, such that they are able to timely takeover control for the electronic driving system of the vehicle 22. Giving the driver control of the vehicle 22 generally includes asking the driver to take over control of the vehicle 22, such that the vehicle 22 is taken over by the driver.

Step 128: WAIT UNTIL MANEUVER STARTS. If controller 20 determines that step 124 is positive, method 100 waits until the maneuver starts.

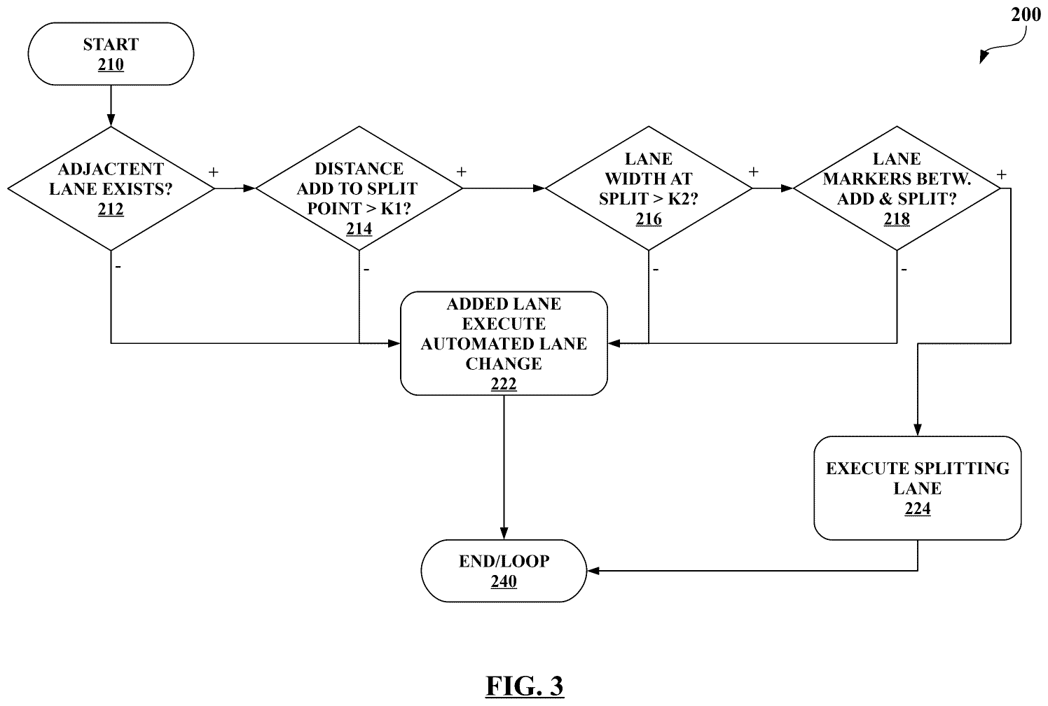

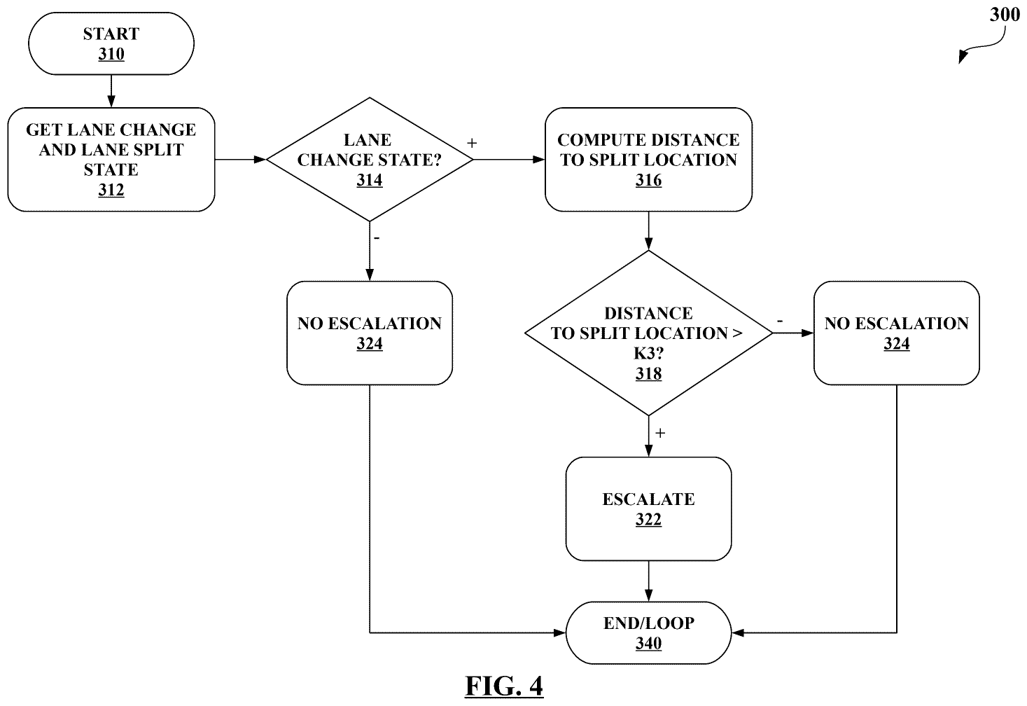

Step 130: CONTINUOUSLY MONITOR HEALTH TRAJECTORY. At step 130 method 100 continuously monitors the health of the planned trajectory. This may include several steps that will be recognized by those having ordinary skill in the art. This includes, without limitation, rationalizing the viability of a created trajectory. Note that the material in FIGS. 3 and 4 may contribute to this decision.

Step 132: TRAJECTORY VALID? At step 132 method 100 includes determining whether the trajectory is valid. This may include several steps that will be recognized by those having ordinary skill in the art.

Step 134: GENERATE URGENT REQUEST FOR DRIVER TAKEOVER. At step 134, if the controller 20 determines at step 132 determines that the answer is negative, method 100 may include notifying the driver of the vehicle 22 that an urgent situation exists, and takeover is needed, generally, but without limitation, immediately. This will require or request that the driver of the vehicle 22 take over control.

Step 136: MANEUVER COMPLETE? At step 136, if the controller 20 determines at step 132 determines that the answer is positive, the controller 20 checks whether the maneuver is complete. In general, controller 20 retains control of the vehicle 22 via an electronic driving system of the vehicle 22. If not yet complete, controller 20 returns to continuously monitoring the health of the planned trajectory. If complete, controller 20 ends/loops.

Step 140: END/LOOP. At step 140, the method 100 ends or loops. Ending/looping may include proceeding back to start step 110 or waiting until called upon to run again, such as by one of the controllers 20 or another portion of the connectivity system 10.

FIG. 3 is a schematic flow chart diagram of a method 200, or methods, for mitigating path planning failure modes in route following application. One or more of the methods described herein may be executed by the controller 20, including the non-transitory computer-readable storage medium, or other structures or equipment recognizable to skilled artisans. Method 200, or other methods, continue mitigating a path by steps that will be recognized by those having ordinary skill in the art.

Step 210: START. At step 210 the method 200 initializes or starts. Method 200 may begin operation when called upon by one or more controllers 20, may be constantly running, or may be looping iteratively.

Step 212: ADJACENT LANE EXISTS OUTSIDE OF ADDED LANE? At step 212, method 200 determines whether there is an additional lane outside of the added lane 24. Note that in many instances, but without limitation, there may not be another lane.

Step 214: DISTANCE FROM ADD POINT TO SPLIT POINT>K1? At step 214, method 200 determines whether the distance from the add point to the split point is greater than a first distance (K1), i.e., a predetermined or calibrated linear distance. This includes determining the first distance.

Step 216: LANE WIDTH AT SPLIT POINT>K2? At step 216, method 200 determines whether the lane width is greater than a second distance (K2), i.e., a predetermined or calibrated linear distance.

Step 218: LANE MARKERS BETWEEN ADD AND SPLIT? At step 218, method 200 determines whether there are lane markers between the lane opening 28 and/or the split point 30. This may occur via optical processing, which may be included in the, likely forward, sensors of the vehicle 22.

Step 222: ADDED LANE EXECUTE AUTOMATED LANE CHANGE. At step 222, method 200 includes executing the automated lane change. Note that if any of steps 212-218 are answered negatively, this is the result.

Step 224: EXECUTES SPLITTING LANE. At step 224, method 100 executes the lane slit. Note that if any of steps 212-218 are answered positively, this is the result.

Step 240: END/LOOP. At step 240, the method 200 ends or loops. Ending/looping may include proceeding back to start step 210 or waiting until called upon to run again, such as by one of the controllers 20 or another portion of the connectivity system 10.

FIG. 4 is a schematic flow chart diagram of a method 300, or methods, for mitigating path planning failure modes in route following application. One or more of the methods described herein may be executed by the controller 20, including the non-transitory computer-readable storage medium, or other structures or equipment recognizable to skilled artisans.

Step 310: START. At step 310 the method 300 initializes or starts. Method 300 may begin operation when called upon by one or more controllers 20, may be constantly running, or may be looping iteratively.

Step 312: GET LANE CHANGE AND LANE SPLIT STATE. At step 312, method 300 looks for the added lane 24 or the lane split 26.

Step 314: LANE CHANGE STATE? At step 314, method 300 determines whether there is the added lane 24 or the lane split 26. If the lane split 26 is detected, method 300 moves to step 316.

Step 316: COMPUTE DISTANCE TO SPLIT LOCATION. At step 316, method 300 computes a distance to the lane split distance 36.

Step 318: DISTANCE TO SPLIT LOCATION>K3? At step 318, method 300 determines whether the distance is greater than a third distance (K3), i.e., a predetermined or calibrated linear distance. Note that the distances listed may be arbitrary and may be swapped for one another, and that there may be additional distances.

Step 322: ESCALATE. At step 322, if step 318 is answered positively, method 300 escalates. This may include asking the driver of the vehicle 22 to take over control of the vehicle 22, or following the prior path, but while notifying the driver that they may need to take over control of the vehicle 22. Giving the driver control of vehicle 22 generally includes asking the driver to take over control of the vehicle 22, such that the vehicle 22 is taken over by the driver.

Step 324: NO ESCALATION. At step 324, method 300 does not escalate. Note that if any of steps 314 or 318 are answered negatively, this is the result.

Step 340: END/LOOP. At step 340, the method 300 ends or loops. Ending/looping may include proceeding back to start step 310 or waiting until called upon to run again, such as by one of the controllers 20 or another portion of the connectivity system 10.

The detailed description and the drawings or figures are supportive and descriptive of the subject matter herein. While some of the best modes and other embodiments have been described in detail, various alternative designs, embodiments, and configurations exist.

Furthermore, any examples shown in the drawings or the characteristics of various examples mentioned in the present description are not necessarily to be understood as examples independent of each other. Rather, it is possible that each of the characteristics described in one of the examples of an embodiment can be combined with one or a plurality of other desired characteristics from other examples, resulting in other examples not described in words or by reference to the drawings. Accordingly, such other examples fall within the framework of the scope of the appended claims.

1. A method of mitigating path planning failure modes, comprising:
distinguishing an added lane versus a lane split, such that there are distinguished features;
determining road geometry features from the distinguished features;
determining a first distance between the added lane and the lane split from the distinguished features; and
mitigating a path by one of:
giving a driver control of a vehicle; and
retaining control of the vehicle via an electronic driving system.

2. The method of mitigating path planning failure modes of claim 1, wherein the road geometry features include curvature and a curvature derivative.

3. The method of mitigating path planning failure modes of claim 2, further comprising:
using a go or no go decision to determine whether a driver gets control or whether the vehicle retains control.

4. The method of mitigating path planning failure modes of claim 3, further comprising:
determining whether a distance from add point to split point is greater than a second distance.

5. The method of mitigating path planning failure modes of claim 4, further comprising:
determining whether a lane width at split point is greater than a third distance.

6. The method of mitigating path planning failure modes of claim 5, further comprising:
generating takeover requests for timely ceding control.

7. The method of mitigating path planning failure modes of claim 6, further comprising:
rationalizing viability of a created trajectory.

8. The method of mitigating path planning failure modes of claim 2, further comprising:
determining a second distance between a respective one of the lane adds and a respective one of the lane splits.

9. The method of mitigating path planning failure modes of claim 8, further comprising:
determining whether a lane width at split point is greater than a third distance.

10. The method of mitigating path planning failure modes of claim 9, further comprising:
generating takeover requests for timely ceding control.

11. The method of mitigating path planning failure modes of claim 10, further comprising:
rationalizing viability of a created trajectory.

12. The method of mitigating path planning failure modes of claim 11, further comprising:
using a go or no go decision to determine whether a driver gets control or whether the vehicle retains control.

13. A non-transitory computer-readable storage medium on which is recorded instructions, wherein execution of the instructions by a processor causes the processor to:
distinguish lane adds versus lane splits such that there are distinguished features;
determine road geometry features, including curvature and a curvature derivative from the distinguished features;
determine a first distance between an added lane or a lane split from the distinguished features;
determine whether an adjacent lane exists outside of the added lane from the distinguished features;
determine whether the distance an add point to a split point is greater than a second distance from the distinguished features;
determine whether a lane width at the split point is greater than a third distance from the distinguished features;
determine whether there are lane markers between the lane add and the lane split from the distinguished features; and
mitigate a path by retaining control of a vehicle via an electronic driving system and providing driver notification to take control of the vehicle.

14. A non-transitory computer-readable storage medium on which is recorded instructions, wherein execution of the instructions by a processor causes the processor to, of claim 13:
generate takeover requests for timely ceding control.

15. A non-transitory computer-readable storage medium on which is recorded instructions, wherein execution of the instructions by a processor causes the processor to, of claim 14:
as an alternative to giving a driver control of the vehicle, retaining control of the vehicle via the electronic driving system.

16. A non-transitory computer-readable storage medium on which is recorded instructions, wherein execution of the instructions by a processor causes the processor to, of claim 15:
rationalize viability of a created trajectory as a maneuver is in progress.

17. A method of mitigating path planning failure modes, comprising:
distinguishing lane adds versus lane splits, such that there are distinguished features;
determining road geometry features from the distinguished features;
determining a first distance between an added lane or a lane split from the distinguished features;
determining whether the distance from add point to split point is greater than a second distance from the distinguished features;
determining whether a lane width at split point is greater than a third distance; and
mitigating the path by one of:
giving a driver control of a vehicle; and
retaining control of the vehicle via an electronic driving system.

18. The method of mitigating path planning failure modes of claim 17, wherein the road geometry features include curvature and a curvature derivative.

19. The method of mitigating path planning failure modes of claim 18, further comprising:
generating takeover requests for timely ceding control.

20. The method of mitigating path planning failure modes of claim 19, further comprising:
rationalizing a viability of a created trajectory.
